(19) United States
(12) Patent Application Publication
(10) Pub. No.: US 2021/0012412 A1
(43) Pub. Date: Jan. 14, 2021

(54) DEVICE, SYSTEM AND METHOD FOR PLACING ORDER FROM MULTIPLE SERVICE PROVIDERS AT A SINGLE INSTANCE

(71) Applicant: Azhagarasan Annadorai, Chennai (IN)

(72) Inventor: Azhagarasan Annadorai, Chennai (IN)

(21) Appl. No.: 16/583,281

(22) Filed: Sep. 26, 2019

(30) Foreign Application Priority Data
Jul. 10, 2019 (IN) 201941027728

(51) Int. Cl. G06Q 30/06; G06Q 50/12

(52) U.S. Cl. CPC G06Q 30/0635; G06Q 30/0641; G06Q 30/0631; G06Q 50/12

(57) ABSTRACT

A remote ordering device, system and method to order from different restaurants in a location to serve a single customer via a single order and accompanying charges from a location such as delivery fee, event management fee, service fee etc. A remote ordering device for providing at least one list of at least one item or group of items to an order processing system on each of a plurality of user defined occasions is provided. The remote ordering device can include a first processor coupled with a memory, the memory storing instructions which upon execution by the first processor triggers a second processor. The second processor upon triggered by the first processor enables at least one user to select, in real-time, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items. An incentive scheme is designed to facilitate incentive/commission to the caterer, host and delivery partner.

### FIELD OF DISCLOSURE

The present disclosure relates to the field of remote ordering systems, and in particular to a remote ordering device, system and method to order from different restaurants in a location to serve a single customer via a single order and accompanying charges from a location such as delivery fee, event management fee, service fee etc.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Remote ordering systems have been proposed for providing homeowners and business-persons the ability to order staple items from one or more merchants without the need to travel to a merchant location. However, such prior art systems have failed to provide the user with adequate information necessary for tracking or editing orders made or lists compiled.

Online food ordering is the process of ordering food through the restaurant's own website or mobile app, or through a multi-restaurant's website or app. A customer can choose to have the food delivered or for pick-up. The online food ordering market increased in the U.S with 40 percent of U.S adults having ordered their food online once The online food ordering market includes foods prepared by restaurants, prepared by independent people, and groceries being ordered online and then picked up or delivered.

Potluck concept has been prevalent at different parts of the world without being assisted by commercial merchants; The guests arrive at the potluck party with self-cooked/home-cooked food. It is a common experience that users would like to be able to order dine-in or take-always from multiple restaurants for a small group or large gathering (in advance or while seated in a particular restaurant).

It is a common experience that users would like to be able to order dine-in or take-always from multiple restaurants for a small group or large gathering (in advance or while seated in a particular restaurant). If merchants (restaurants) do not collaborate, this problem will not get addressed. Customers do not want to incur multiple delivery charges, when ordering from multiple restaurants. However, the businesses have not collaborated to provide such experience. Current practices are based on goals to increase market share for a given restaurant either by increasing their footfalls from the total footfall in the location or by taking on catering orders. The methods and practices fail to increase the overall footfalls or market share to a given location, where multi-cuisine restaurants serve.

Thus, it may be appreciated form the above that, there is no device, system and method available in the art today which enables a user to place a single order form multiple service providers in a single instance and to be delivered at a preferred location at a single instance.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### SUMMARY

The present disclosure relates to the field of remote ordering systems, and in particular to a remote ordering device, system and method to order from different restaurants in a location to serve a single customer via a single order and accompanying charges from a location such as delivery fee, event management fee, service fee etc.

In an aspect the present disclosure provides a device, a system and a method to incentivize restaurants and partners to attract customers to place single order with multiple restaurants, serve and improve collaboratively in the given location for common good.

In an aspect the present disclosure provides a device, a system and a method to bring restaurants and partners together to cater or host multi cuisine events and parties for the purpose of promoting a location or businesses by the river, beach or a scenic picnic spot.

In an aspect the present disclosure provides a device, a system and a method to facilitate potluck parties served by multiple restaurants in a location, collaborating to host, deliver and cater the food for mutual benefits and operating within guiding/operating principles and business model to motivate the partners just enough to participate and collaborate.

In another aspect the present disclosure provides a device, a system and a method that re-creates the dining experience by the river banks primarily; But not limited to it. Customers shall choose to get the multi-cuisine food delivered to public places such as parks or private locations such as club house, barbeque pit, home etc. System terms this method as “SPOTLUCK”. System also allows the premium customers to designate this favorite dining spot in a location. It may be appreciated that, the system and/or method as proposed in accordance to the present invention is interchangeably referred to hereinafter as “spotluck”.

In another aspect the present disclosure provides a device, a system and a method that recommends adjustment of incentives to enable collaboration between multiple restaurants to provide for catering, delivering and hosting services and thereby enable customers to order variety items from multiple restaurants via single order.

### BRIEF DESCRIPTION OF DRAWINGS

The accompanying drawings are included to provide further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates an exemplary representation of a remote ordering system according to the present invention, in accordance with an exemplary embodiment of the present disclosure.

FIG. 2 illustrates exemplary functional modules of the remote ordering system, in accordance with an exemplary embodiment of the present disclosure.

FIG. 3A illustrates an exemplary flowchart of working of the remote ordering system, in accordance with an exemplary embodiment of the present disclosure.

FIG. 3B illustrates an exemplary working of the remote ordering system, in accordance with an exemplary embodiment of the present disclosure.

FIG. 4 illustrates an exemplary partner ecosystem for the remote ordering system, in accordance with an exemplary embodiment of the present disclosure.

FIGS. 5A-5B illustrates an exemplary flowchart providing selection according to the remote ordering system (potluck), in accordance with an exemplary embodiment of the present disclosure.

FIG. 6 illustrates an exemplary method of working of the remote ordering system, in accordance with an exemplary embodiment of the present disclosure.

FIG. 7 illustrates an exemplary computer system utilized for implementation of the proposed smart mirror in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may he used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The software programs include modules to automate transactions through pre-defined and configurable rules, provide visualized data via charts, tables and graphs fOr human consumption of data and include artificial intelligence (AI) models and programs that simulate human brain to improvise the process of incentivizing, labeling and predicting demands etc. The machine-readable medium may include, but is not limited to, fixed (hard) drives, cloud storage (e.g., google drive, one drive, drop box, amazon s3) magnetic tape, floppy diskettes, optical disks, compact disc read-only memories (CD-ROMs), and magneto-optical disks, semiconductor memories such as ROMs, PROMs, random access memories (RAMs), programmable read-only memories (PROMS), erasable PROMs (EPROMs), electrically erasable PROMs (EEPROMs), flash memory, magnetic or optical cards, or other type of media/machine-readable medium suitable far storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

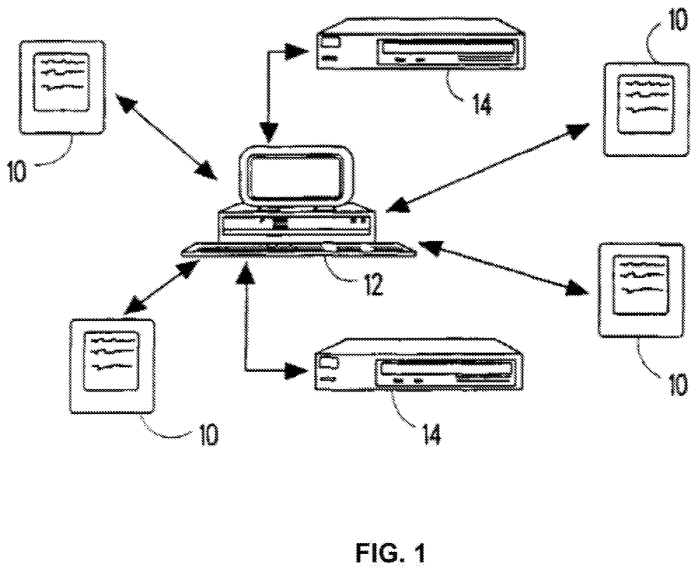

FIG. 1 illustrates an exemplary representation of a remote ordering system according to the present invention, in accordance with an exemplary embodiment of the present disclosure.

A remote ordering system according to the present invention and FIG. 1 includes at least one user device referred to as a display/processor unit (DPU) 10 or a remote ordering terminal, a data format/transfer computer (DFTC) 12 (also referred to as a central processing means or a central computer), and at least one merchant database 14 (also referred to as a central inventory database). In an exemplary embodiment used in the present description, one DPU 10 is in communication with one merchant database 14 through a DFTC 12. However, it is envisaged that each system will typically have multiple DPUs 10 and merchant databases 14.

While a discrete piece of hardware has been identified as the merchant database 14 in FIG. 1, it is to be understood that throughout this document the merchant database 14 refers to a database of information not having one specific physical location. That is, the merchant database 14 can be physically located within the DFTC 12, within another computer or memory device located at the site of the DFTC 12 and connected thereto, or within a computer or memory device at a merchant location.

It would be appreciated that aspects of the present disclosure can be applied to a variety of network architectures, all of which are well within the scope of the present disclosure.

Although the present subject matter is explained considering that the present invention is implemented as “remote ordering system”, it may be understood that the present invention may also be implemented in a variety of computing systems, such as a laptop computer, a desktop computer, a notebook, a workstation, a server, a network server, a cloud-based environment and the like. It would be appreciated that the remote ordering system may be accessed by multiple users (not show), through one or more applications residing on the remote ordering system, or applications residing on the computing devices (not shown) connected to the remote ordering system.

In an aspect, the remote ordering system can be operatively coupled to a website and so be operable from any Internet enabled remote ordering system. Examples of the remote ordering system may include, but are not limited to, a smart mirror, a portable computer, a personal digital assistant, a handheld device, and a workstation. The remote ordering system may be communicatively coupled to the server through a network.

It may be also understood that the remote ordering system can be a wearable device to be worn by a user and having wearable technology, wearables, fashionable technology, wearable devices, tech togs, or fashion electronics embedded in them.

In one implementation, the network can be a wireless network, a wired network or a combination thereof. The network can be implemented as one of the different types of networks, such as intranet, local area network (LAN), wide area network (WAN), the internet, and the like. Further, the network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 can include a variety of network devices, including routers, bridges, servers, computing devices, storage devices, and the like.

In an aspect, the remote ordering system can include one or more Internet of Things (IoT) devices. In a typical network architecture of the present disclosure can include a plurality of network devices such as transmitter, receivers, and/or transceivers that may include one or more IoT devices.

As used herein, the IoT devices can be a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a WiFi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

IoT devices may include home automation network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). Network device may include a home automation switch that may be coupled with a home appliance. In some embodiments, network devices may be used in other environments, such as a business, a school, an establishment, a park, or any place that can support a local area network to enable communication with network devices. For example, a network device can allow a user to access, control, and/or configure devices, such as office-related devices (e.g., copy machine, printer, fax machine, or the like), audio and/or video related devices (e.g., a receiver, a speaker, a projector, a DVD player, a television, or the like), media-playback devices (e.g., a compact disc player, a CD player, or the like), computing devices (e.g., a home computer, a laptop computer, a tablet, a personal digital assistant (PDA), a computing device, a wearable device, or the like), lighting devices (e.g., a lamp, recessed lighting, or the like), devices associated with a security system, devices associated with an alarm system, devices that can be operated in an automobile (e.g., radio devices, navigation devices), and/or the like.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using Zigbee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). A wired network may include any wired interface (e.g., fiber, Ethernet, powerline, Ethernet over coaxial cable, digital signal line (DSL), or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network using particular communications protocols, such as WiFi™ (e.g., IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point, Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

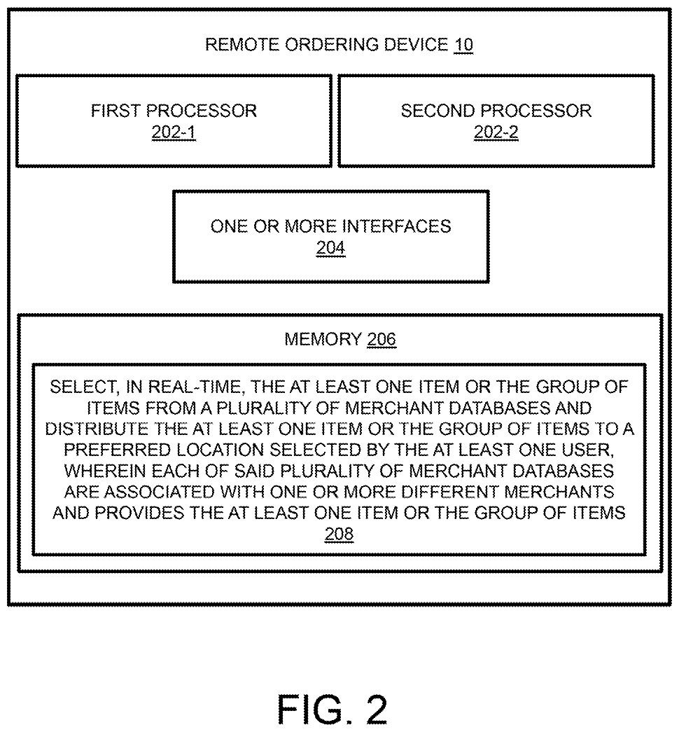

FIG. 2 illustrates exemplary functional modules of the remote ordering system, in accordance with an exemplary embodiment of the present disclosure. In one embodiment, the remote ordering system 10 may include a plurality of processors for example, a first processor 202-1, and a second processor 202-2, an input/output (I/O) interface 204, and a memory 206. Each of the first processor 202-1 and the second processor 202-2 may be implemented as one or more microprocessors, microcomputers, microcontrollers, digital signal processors, central processing units, state machines, logic circuitries, and/or any devices that manipulate signals based on operational instructions. Among other capabilities, each of the first processor 202-1 and the second processor 202-2 is configured to fetch and execute computer-readable instructions stored in the memory 206.

The I/O interface 204 may include a variety of software and hardware interfaces, for example, a web interface, a graphical user interface, and the like. The I/O interface 204 may allow the remote ordering system 10 to interact with a user directly or through the client/computing devices 104. Further, the 110 interface 204 may enable the remote ordering system 10 to communicate with other computing devices, such as web servers and external data servers. The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules, routines, programs, objects, components, data structures, etc., which perform particular tasks or implement particular abstract data types.

In an embodiment, a remote ordering device 10 for providing at least one list of at least one item or group of items to an order processing system on each of a plurality of user defined occasions is provided. The remote ordering device can include a first processor coupled with a memory, the memory storing instructions which upon execution by the first processor triggers a second processor.

The second processor upon triggered by the first processor enables at least one user to select, in real-time, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items.

In an exemplary embodiment, said order processing system forming an interface between said device and the plurality of merchant databases.

In an exemplary embodiment, each of said plurality of merchant databases is associated with same merchant.

In an exemplary embodiment, the at least one item or group of items having an item code associated therewith.

In an exemplary embodiment, the at least one item or group of items is a food item.

In an exemplary embodiment, the second processor, before enabling the at least one user to select the at least one item or the group of items, is configured to retrieve a current location of the at least one user operating said remote ordering device in real-time. In another exemplary embodiment, it receives one or more preferences to apply one or more filter, each of the one or more preferences are associated with the at least one item or the group of items in real-time.

In an exemplary embodiment, the remote ordering device enables the at least one user to place an order from different restaurants located at different locations to be distributed to the preferred location via a single order.

In an exemplary embodiment, the remote ordering device is configured to provide one or more recommendations associated with one or more services selected form a group comprising: a host, a caterer, a delivery provider, a system/platform provider, an advertiser, a service provider, a sponsor, a spotluck space provider, and customers.

In an exemplary embodiment, the at least one user defined occasion from the plurality of user defined occasions is a spotluck.

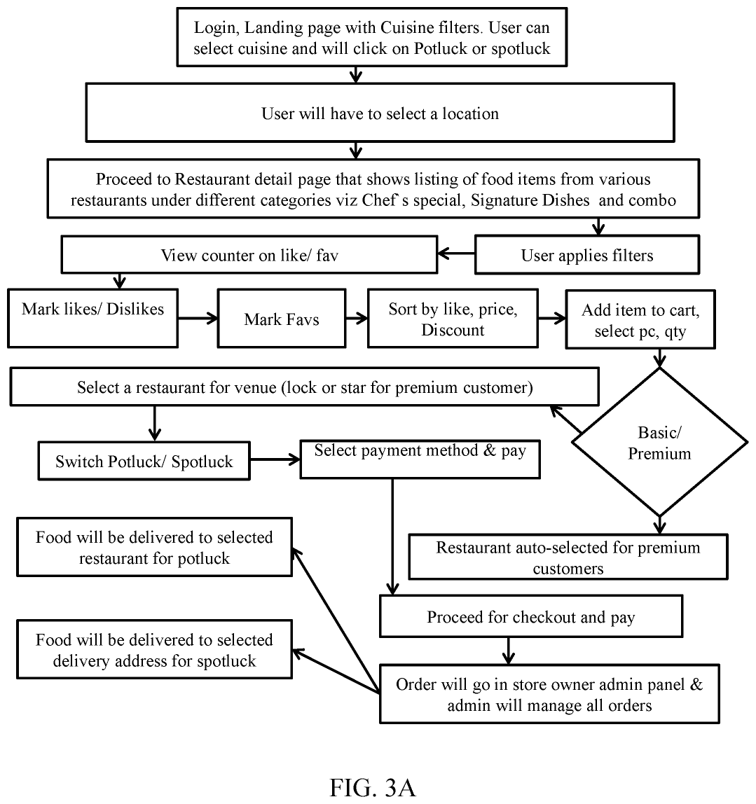

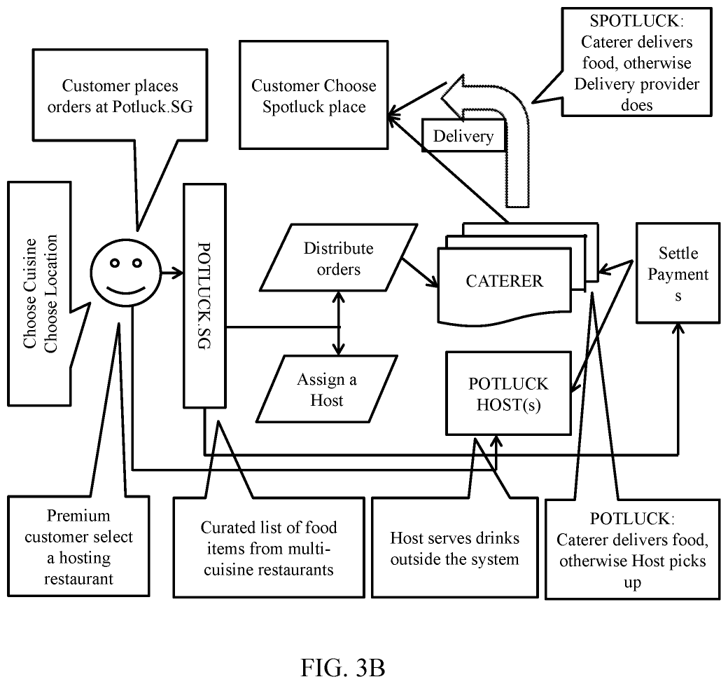

FIG. 3A illustrates an exemplary flowchart of working of the remote ordering system, in accordance with an exemplary enibodiment of the present disclosure. Further, FIG. 3B illustrates an exemplary working of the remote ordering system, in accordance with an exemplary embodiment of the present disclosure.

In an embodiment the present disclosure provides a device, a system and a method to incentivize restaurants and partners to attract customers to place single order with multiple restaurants, serve and improve collaboratively in the given location for common good.

In an embodiment the present disclosure provides a device, a system and a method to bring restaurants and partners together to cater or host multi cuisine events and parties for the purpose of promoting a location or businesses by the river, beach or a scenic picnic spot.

In an embodiment the present disclosure provides a device, a system and a method to facilitate potluck parties served by multiple restaurants in a location, collaborating to host, deliver and cater the food and drinks for mutual benefits and operating within guiding/operating principles and business model to motivate the partners just enough to participate and collaborate.

In another embodiment the present disclosure provides a device, a system and a method that re-creates the dining experience by the river banks primarily; However allows the premium customers to designate their favorite dining spot, be it a restaurant by the river or public places such as parks or private locations such as club house, barbeque pit, home etc. At additional charge, customers can avail additional services such as event management/managers, marketing promotions such as welcome banners, recreational activities such as belly dancing etc.

In another embodiment the present disclosure provides a device, a system and a method that recommends adjustment of incentives to enable collaboration between multiple restaurants to provide following services and thereby enable customers to order variety items from multiple restaurants via single order.

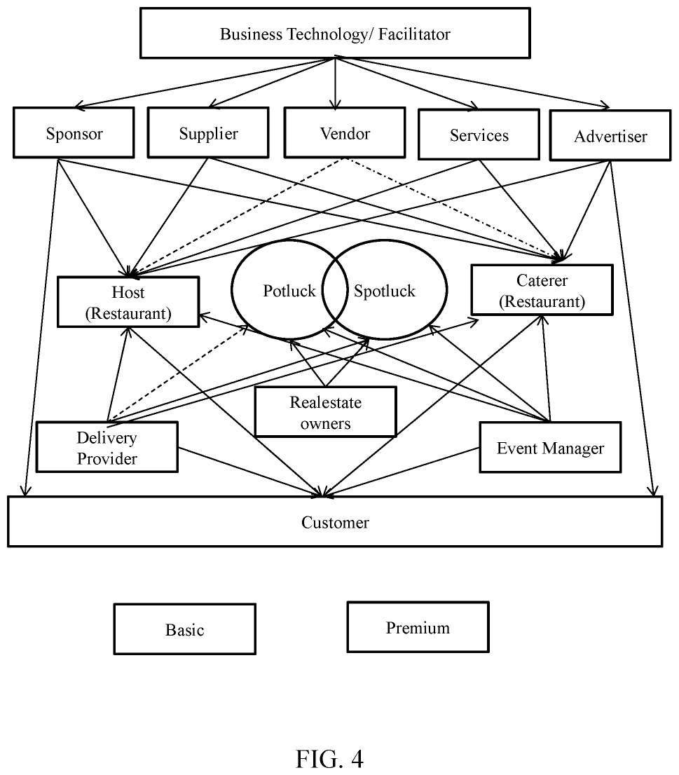

FIG. 4 illustrates an exemplary partner ecosystem for the remote ordering system, in accordance with an exemplary embodiment of the present disclosure. The system according to the present invention envisages the partners (some of the exemplary partners are as provided in FIG. 4) making up the ecosystem. Restaurants are the key partners who would have more incentive for the food produced/delivered or for the potluck party hosted. Other partners are adequately incentivized for providing the new potluck experience to customers and to benefit from the ecosystem by servicing each other.

A remote ordering device, system and method to order from different restaurants in a location to serve a single customer via a single order and accompanying delivery charge from a location. A remote ordering device for providing at least one list of at least one item or group of items to an order processing system on each of a plurality of user defined occasions is provided. The remote ordering device can include a first processor coupled with a memory, the memory storing instructions which upon execution by the first processor triggers a second processor. The second processor upon triggered by the first processor enables at least one user to select, in real-time, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items. An incentive scheme is designed to facilitate incentive/commission to the caterer, host and delivery partner.

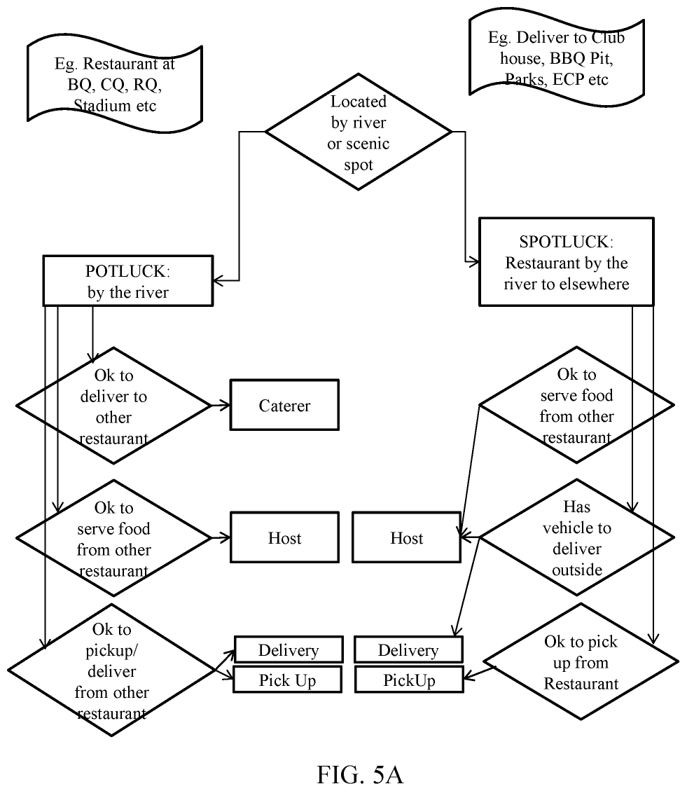

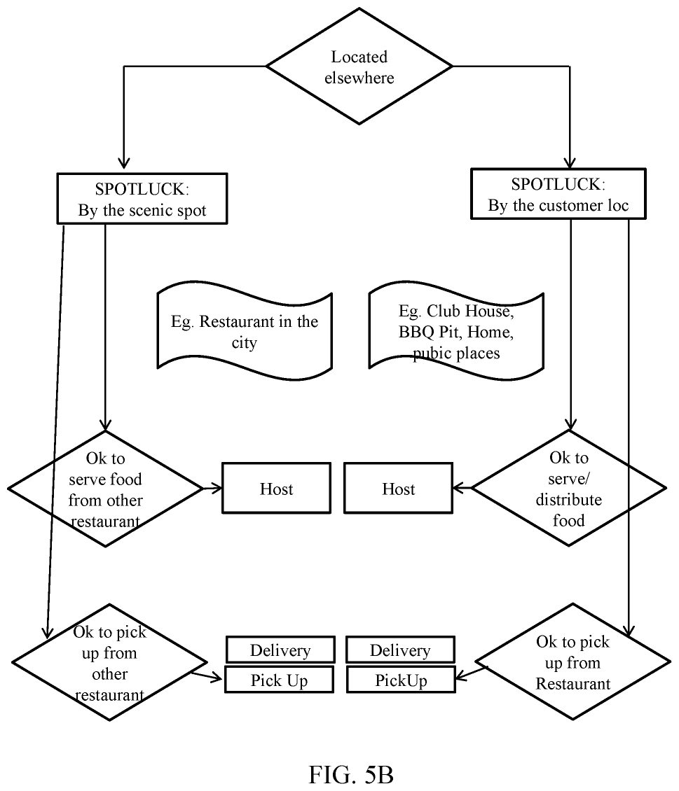

FIGS. 5A-5B illustrates an exemplary flowchart providing selection according to the remote ordering system (potluck), in accordance with an exemplary embodiment of the present disclosure.

In an exemplary embodiment, as shown in FIGS. 3A-5B, a user may select a riverside location and proceed to a page where items from multiple restaurants are listed under different categories such as Chef's Special, Signature Dishes, Today's Deal, Specials etc. The items may be curated so that similar items are not featured by more than 3 restaurants. Items may bear logo of the restaurant to help the customers identify the participating restaurant. Search filters such as cuisine, dietary preference, dish type, ranking may be based on ‘customer likes’, popularity based on # of orders with this item etc will help customers to select the dishes preferred by potluck party participants. Once the order is placed, restaurants are notified about the upcoming potluck patty order. Restaurants may accept to process the order and optionally deliver to the host restaurant where the party will take place. Every order may be auto-assigned a restaurant from the pool of restaurants that participate in the program. If a restaurant is NOT available to host for any reason, the next restaurant in the order will get the opportunity to host the party (no rain check). Premium customers shall have privileges to select a restaurant of their choice, waiver of entry fee to premium potluck/spotluck locations and other such value added services.

In an exemplary embodiment, the user who may be the paid members will have an option to select a restaurant. Other such privileges are available for paid members. Certain other fees are applicable to certain dining spots; either due to premium locality or requires additional services. These fees such as entry fee to premium potluck/spotluck locations and fee for value added services may be waived for paid members.

If a restaurant declines an item or all items in the order, potluck will confirm the availability of other 2 similar items, and notify customer with recommendation. If the catering restaurant declines to deliver the item to the host restaurant, the host restaurant will be requested to pick up the items from catering restaurant (caterer). If neither caterer nor host restaurant deny delivery service, Potluck team or 3rd party delivery service provider will be assigned to carry out the pickup from caterer and delivery to the host for the order. The value of food item will be shared to the participants in the % as below. The % will be revised time to time to reflect the demand and fairness.

In an exemplary embodiment, the present invention may recommend adjustment of incentives to enable collaboration between multiple restaurants to provide following services and thereby enable customers to order variety items from multiple restaurants via single order. For example, the incentives for the Caterer: 30%, Host: 30%, Delivery: 30%, and Potluck System Fee: 10%.

In an exemplary embodiment, the primary incentive premises, may include but are not limited to, the following:
i. Host, Caterer and delivery provider share 30% of the tbod cost
ii. Platform provider/enabler earns 10% of the food cost
iii. Caterer shall have the preference to deliver food
iv. Host restaurant shall get the preference to serve drinks
v. If caterer declines to deliver, Host will get the option to pickup from caterer. If Host also declines, delivery provide of potluck team will manage the delivery for 30% commission.
vi. Host shall be auto-selected from the pool of available restaurants in a location
vii. The host shall pass the opportunity to host; but shall not have a rain check to serve later.
viii. Delivery provider earns 30% of order cost/food cost for managing delivery and keeping host, caterer and customer informed.

In an exemplary embodiment, the system according to the present invention may offer checks and balances to incentives for various parties in the ecosystem. The major incentives are laid out as below:
1. Key Partners
1.1.1.1. Host
1. Earns 30% of the order
2. Has the privilege to supply drinks for the customers
3. Earns additional 30% more for food pickup from caterer, if caterer chooses not to deliver to the host. Delivery privilege is given to Caterers.
4. Avail discounted/competitive services from service providers
1.1.1.2. Caterer
1. Lure customers driven by taste to experience chef's special and gain visibility
2. Lure customers driven by discounts to try signature dishes with discounts from 25-50%
3. Offer packages to meet typical customer choices at an optimized cost
4. Earn 30% for food & 30% more to deliver (optional) food to the hosting restaurant
1.1.1.3. Delivery Provider
1. Earns 30% to pick up food from multiple restaurants in a location and deliver to the hosting restaurant
1.1.1.4. System/Platform Provider
1. Earns 10% for the system provided and maintained
2. Earns from membership fees of restaurants; such membership fee can be sponsored by partners (sponsors) to earn goodwill from restaurants
3. Earns from memberships of customers; such membership fee can be sponsored by partners (sponsors) to provide value-added services to their customers
4. Earns 10% of profit for the services provided by the service provider
5. Earns 10% of project cost for the system enhancements and other projects outside the scope of the system. Costs of the projects are to be borne by the partners who are benefited by the project. Projects are selected by voting in the system.
2. Other Parties/Entities
1.1.2.1. Advertiser
1. Gain brand visibility among restaurants or customers or both
1.1.2.2. Service provider
1. Gets an opportunity to bid for a service and provide service to the restaurants
1.1.2.3. Sponsor
1. Sponsors membership fees for restaurants to earn goodwill among restaurants
2. Gains visibility in the platform is Sponsors listing (qualitative)
1.1.2.4. Delivery Provider
1. Stated earlier (earn 30% to pickup & drop food)
1.1.2.5. Spotluck Space Provider
1. Same as the host. earn 30% to host.
2. Sublets the space to hosts for 50% profit on the space or a fixed monthly rental
3. Leases or owns the space. Pays 10% of profits (or as agreed), if the space is otherwise unused & maintained by 3rd parties or government
4. New businesses can compete to provide spaces
3. Customers
Basic Members
1. New way of organizing potluck parties with support from restaurants and businesses
2. Able to order multiple cuisine food from different restaurants from single order
3. Pays optimized delivery cost, as delivery is consolidated in one location
4. Gets assigned a venue that meets customer's location preference
5. New dining experience with unlimited combination of food choices
Premium members
1. All benefits of basic plan
2. Reserve a specific restaurant to be the host
3. Waiver of entry fee or other special fee at the discretion of spotluck space provider

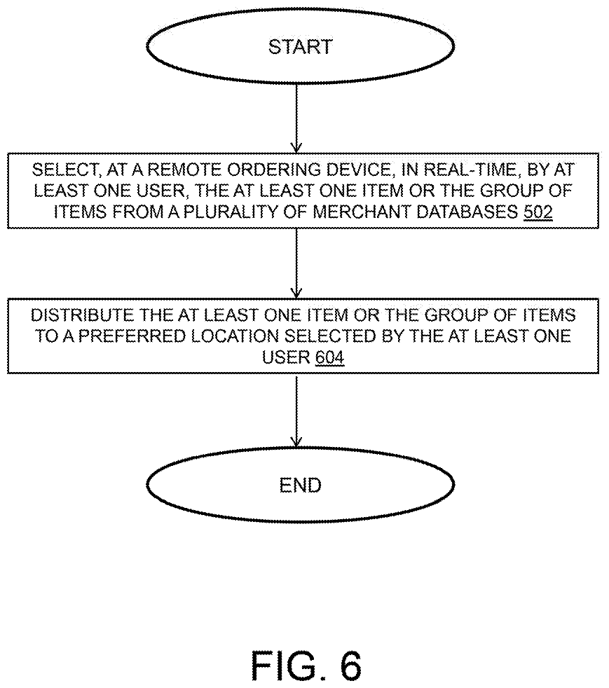

FIG. 6 illustrates an exemplary method of working of the remote ordering system, in accordance with an exemplary embodiment of the present disclosure. The method may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the protection scope of the subject matter described herein. Furthermore, the method can be implemented in any suitable hardware, software, firmware, or combination thereof. However, for ease of explanation, in the embodiments described below, the method may be considered to be implemented in the above the proposed the remote ordering device 10.

At step 602, the remote ordering device selects by at least one user, the at least one item or fhe group of items from a plurality of merchant databases in real-time. In an exemplary embodiment, each of said plurality of merchant databases are associated with one or more different merchants and provides the at least one item or the group of items.

At step 604, the remote ordering device distributes the at least one item or the group of items to a preferred location selected by the at least one user.

In an exemplary embodiment, said order processing system forming an interface between said device and the plurality of merchant databases.

In an exemplary embodiment, each of said plurality of merchant databases is associated with same merchant.

In an exemplary embodiment, the at least one item or group of items having an item code associated therewith.

In an exemplary embodiment, the at least one item or group of items is a food item.

In an exemplary embodiment, the second processor, before enabling the at least one user to select the at least one item or the group of items, is configured to retrieve a current location of the at least one user operating said remote ordering device in real-time. In another exemplary embodiment, it receives one or more preferences to apply one or more filter, each of the one or more preferences are associated with the at least one item or the group of items in real-time.

In an exemplary embodiment, the remote ordering device enables the at least one user to place an order from different restaurants located at different locations to be distributed to the preferred location via a single order.

In an exemplary embodiment, the remote ordering device is configured to provide one or more recommendations associated with one or more services selected form a group comprising: a host, a caterer, a delivery provider, a system/platform provider, an advertiser, a service provider, a sponsor, a spotluck space provider, and customers.

In an exemplary embodiment, the at least one user defined occasion from the plurality of user defined occasions is a spotluck. Spotluck is an option provided to customers where they get to plan/manage a party either on their own or with assistance from parties.

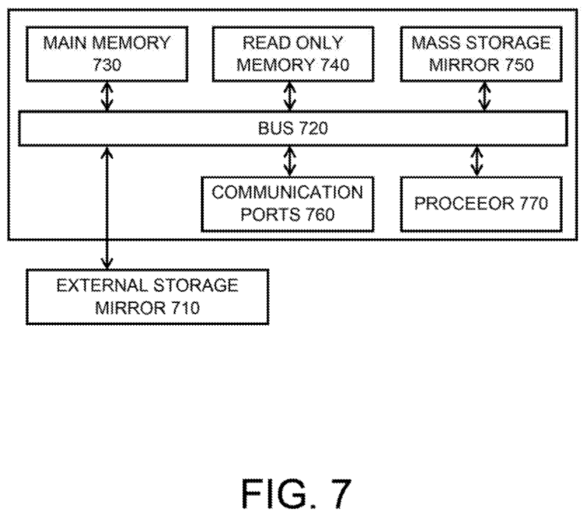

FIG. 7 illustrates an exemplary computer system utilized for implementation of the proposed smart mirror in accordance with an exemplary embodiment of the present disclosure. In an embodiment, the proposed the remote ordering device 10 can be implemented in the computer system to enable aspects of the present disclosure. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown in the FIG. 7, the computer system includes an external storage device 710, a bus 720, a main memory 730, a read only memory 740, a mass storage device 750, communication port 760, and a processor 770. A person skilled in the art will appreciate that computer system may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system connects. Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATH) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 820 communicatively couples processor(s) 470 with the other memory, storage and communication blocks. Bus 720 can be, e.g. a Peripheral Component Interconnect (PCI) PCI Extended (PCI-X) bus, Small Computer System Interface (SCSI), USB or the like, for connecting expansion cards, drives and other subsystems as well as other buses, such a front side bus (FSB), which connects processor 770 to software system. Optionally, operator and administrative interfaces, e.g. a display, keyboard, and a cursor control device, may also be coupled to bus 720 to support direct operator interaction with computer system. Other operator and administrative interfaces can be provided through network connections connected through communication port 560. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. ln no way should the aforementioned exemplary computer system limit the scope of the present disclosure.

Although the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. All such modifications and embodiments are completely within the scope of the present disclosure.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted, as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the protection scope of the appended claims.

1. A remote ordering device for providing at least one list of at least one item or group of items to an order processing system on each of a plurality of user defined occasions, the remote ordering device comprising:
a first processor coupled with a memory, the memory storing instructions which upon execution by the first processor triggers a second processor to enable at least one user to select, in real-time, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items based at least on a set of pre-determined incentives.

2. The remote ordering device as claimed in claim 1, wherein said order processing system forming an interface between said device and the plurality of merchant databases.

3. The remote ordering device as claimed in claim 1, Wherein each of said plurality of merchant databases is associated with same merchant.

4. The remote ordering device as claimed in claim 1, wherein the at least one item or group of items having an item code associated therewith.

5. The remote ordering device as claimed in claim 1, wherein the at least one item or group of items is a food item.

6. The remote ordering device as claimed in claim 1, wherein the second processor, before enabling the at least one user to select the at least one item or the group of items, is configured to:
retrieve, in real-time, a current location of the at least one user operating said remote ordering device; and
receive, in real-time, one or more preferences to apply one or more filter, each of the one or more preferences are associated with the at least one item or the group of items.

7. The remote ordering device as claimed in claim 1, wherein the remote ordering device enables the at least one user to place an order from different restaurants located at different locations to be distributed to the preferred location via a single order.

8. The remote ordering device as claimed in claim 1, wherein the remote ordering device is configured to provide one or more recommendations associated with one or more services selected form a group comprising: a host, a caterer, a delivery provider, a system/platform provider, an advertiser, a service provider, a sponsor, a spotluck space provider, and customers.

9. The remote ordering device as claimed in claim 1, wherein at least one user defined occasion from the plurality of user defined occasions is a spotluck.

10. A method for providing at least one list of at least one item or group of items to an order processing system on each of a plurality of user defined occasions, the method comprising:
selecting, at a remote ordering device, in real-time, by at least one user, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items based at least on an incentive pre-determined for any or a combination of a host, a caterer and a delivery partner.

11. The method of claim 10, further comprising: enabling the at least one user of remote ordering device to place at least one order from a plurality of restaurants in a location.

12. The method of claim 10, further comprising: enabling the at least one user of remote ordering device to place at least one order from a plurality of restaurants in a location to facilitate a potluck event at said location.

13. The method of claim 10, further comprising: enabling the at least one user of remote ordering device to place at least one order from a plurality of restaurants in a location.

14. A method for providing at least one list of at least one item or group of items to an order processing system on each of a plurality of user defined occasions, the method comprising:
selecting, at a remote ordering device, in real-time, by at least one user, the at least one item or the group of items from a plurality of merchant databases and distribute the at least one item or the group of items to a preferred location selected by the at least one user, wherein each of said plurality of merchant databases are associated with one or more different merchants and provides the at least one item or the group of items based at least on a set of pre-determined incentives.

15. The method of claim 14, further comprising: enabling the at least one user of remote ordering device to place at least one order from a plurality of restaurants in a location.

16. The method of claim 14, further comprising: enabling the at least one user of remote ordering device to place at least one order from a plurality of restaurants in a location to facilitate a potluck event at said location.

17. The method of claim 14, further comprising: enabling the at least one user of remote ordering device to place at least one order from a plurality of restaurants in a location.

18. The method of claim 14, wherein the remote ordering device enables the at least one user to place an order from different restaurants located at different locations to be distributed to the preferred location via a single order.

19. The method of claim 14, wherein the remote ordering device is configured to provide one or more recommendations associated with one or more services selected form a group comprising: a host, a caterer, a delivery provider, a system/platform provider, an advertiser, a service provider, a sponsor, a spotluck space provider, and customers.

20. The method of claim 14, wherein at least one user defined occasion from the plurality of user defined occasions is a spotluck
